(19) United States
(12) Patent Application Publication
(10) Pub. No.: US 2007/0236630 A1
(43) Pub. Date: Oct. 11, 2007

(54) LIQUID CRYSTAL DISPLAY DEVICE

(75) Inventors: Keiji TAGO, Fukaya-shi (JP); Hirokazu MORIMOTO, Fukaya-shi (JP); Yoshitaka YAMADA, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology, Tokyo (JP)

(21) Appl. No.: 11/625,615

(22) Filed: Jan. 22, 2007

(30) Foreign Application Priority Data
Apr. 5, 2006 (JP) 2006-104528

(51) Int. Cl. G02F 1/1335

(52) U.S. Cl. 349/96

(57) ABSTRACT

In order to realize a thinner liquid crystal display, supporting layers which would otherwise be respectively disposed in polarizing plates, each of which is at the side of a liquid crystal cell, are excluded. And retardation films, which are respectively disposed in the polarizers, each of which is at the side of the liquid crystal cell, are used with an additional function as protective layers of the polarizers. In order to reduce display unevenness, absorption axes of the polarizers are neither parallel nor perpendicular to slow axes respectively of the retardation films. Moreover, the absorption axes of the polarizers are neither parallel nor perpendicular to any one of the sides of the respective retardation films.

### CROSS-REFERENCE TO RELATED APPLICATIONS

This application is based upon and claims the benefit of priority from Japanese Patent Application No. 2006-104528 filed on Apr. 5, 2006; the entire contents of which are incorporated herein by reference.

### BACKGROUND OF THE INVENTION

1. Field of the Invention

The present invention relates to a technique for realizing thinner polarizing plates of a liquid crystal display device, and for concurrently realizing reduction in display unevenness.

2. Description of the Related Art

In recent years, light, thin and low-power-consuming liquid crystal display devices have been desired in the field of portable information terminal devices including mobile phones and smartphones. The demand for techniques for realizing thinner liquid crystal devices have been especially strong since the thickness of a liquid crystal display device affects freedom in designing the portable information terminal devices. For instance, the technique disclosed in Japanese laid-Open Patent Application No. 2005-49398 has been known as a technique for realizing a thinner liquid crystal display device.

The portable information terminal devices are used not only indoors but also outdoors. For this reason, a semi-transparent liquid crystal display device with information displayed thereon highly visible both indoors and outdoors is suitable for the portable information terminal devices.

As illustrated in FIG. 1, a polarizing plate 5 of a liquid crystal display device is configured of a polarizer 51, two supporting layers 52 made of triacetylcellulose (TAC), and a retardation film 53. The polarizer 51 is interposed between the supporting layers 52, and is thus protected. The supporting layers 52 are adhered respectively to surfaces of the polarizer 51 with adhesives 54. The retardation film 53 is adhered to a surface of the supporting layer 52, which surface is at the side of a liquid crystal cell, with an adhesive 54.

As described, not only polarizer but also retardation film is necessary to produce a liquid crystal display device. This increases the thickness of the liquid crystal device. In order to realize a thinner polarizing plate, a configuration has been considered in which a retardation film is used with an additional function as a supporting layer for protecting a polarizer, and in which a supporting layer at the side of a liquid crystal cell is excluded.

The polarizer is manufactured by stretching polyvinyl alcohol (PVA). The direction in which PVA is stretched is the absorption-axis direction of the polarizer. The polarizer shrinks in the absorption-axis direction due to heat. For this reason, in a case where the retardation film is adhered to the polarizer with an additional function as a supporting layer, a force is locally applied to the retardation film so that the direction of a slow axis of the retardation film deviates from the original direction, and a retardation value thereof deviates from its original value. This causes a problem that display unevenness occurs, especially when black is displayed, since light leaks out of portions inflicted with the deviation in the direction of the slow axis, and in the retardation value.

### SUMMARY OF THE INVENTION

An object of the present invention is to realize a thinner liquid crystal display device, and to reduce display unevenness thereof by reducing the deviation of the slow axis of a retardation film from its original direction and the deviation of a retardation value from its original value, the deviations being due to shrinkage of a polarizer.

A liquid display device of a first aspect of the present invention includes a liquid crystal cell and a pair of polarizing plates. The liquid crystal cell includes a liquid crystal layer between an array substrate and a counter substrate, which are disposed opposite to each other. The polarizing plates are provided respectively to both surfaces of the liquid crystal cell. In the liquid crystal display device, each of the polarizing plates includes a polarizer, a retardation film and a supporting layer. The retardation film is disposed on the surface of the polarizer, which surface is at the side of the liquid crystal cell, in order to protect the polarizer, and has the slow axis neither parallel nor perpendicular to the absorption axis of the polarizer. The supporting layer is disposed on the other surface of the polarizer in order to protect the polarizer.

In the present invention, the retardation film is used with an additional function as a layer for protecting the surface of the polarizer which surface is at the side of the liquid crystal cell. A supporting layer that would otherwise be at the side of the liquid crystal cell is thus unnecessary. This makes it possible to thin the polarizing plates.

In addition, the slow axis of the retardation film is neither parallel nor perpendicular to the absorption axis of the polarizer. Thereby, it is possible to reduce the deviation of the slow axis of the retardation film from its original direction and the deviation of a retardation value from its original value, the deviations being due to shrinkage of a polarizer in the case where the slow axis of the retardation film is parallel or perpendicular to the absorption axis of the polarizer.

In the liquid display device of a second invention, the absorption axis of the polarizer is neither parallel nor perpendicular to any of the sides of the retardation film. The force that is applied to the retardation film since the polarizer shrinks is thus dispersed to the sides of the retardation film.

Thereby, it is possible to further reduce the deviation of the slow axis of the retardation film from its original direction and the deviation of a retardation value from its original value.

### BRIEF DESCRIPTION OF THE DRAWINGS

FIG. 1 is a cross-sectional view showing a configuration of a polarizing plate used for a conventional liquid crystal display device.

FIG. 2 is a cross-sectional view showing a configuration of a liquid crystal display device of an embodiment.

FIG. 3 is an exploded perspective view showing a configuration of a pair of polarizing plates of a liquid crystal display device of the embodiment, the polarizing plates being disposed in a way that a crystal cell is interposed between the polarizing plates.

FIG. 4 is an image showing display unevenness appearing in the liquid crystal display device of the embodiment.

FIGS. 5A and 5B are images showing display unevenness appearing in crystal display devices of comparative examples.

FIG. 6 is a cross-sectional view showing a configuration of a liquid crystal cell of the liquid crystal display device of the embodiment.

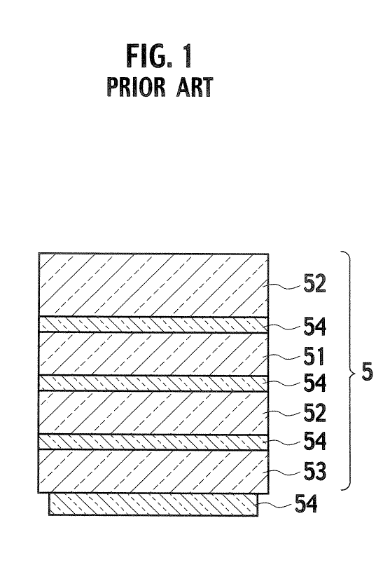

### DESCRIPTION OF THE EMBODIMENT

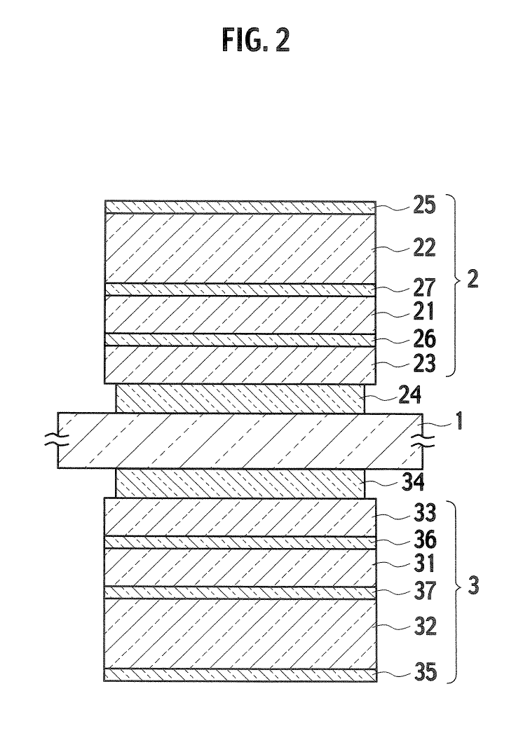

As shown in a cross-sectional view of FIG. 2, a liquid crystal display device of an embodiment includes a crystal cell 1 and a pair of polarizing plates 2 and 3. The polarizing plates 2 and 3 are adhered to the crystal cell 1 respectively with adhesives 24 and 34.

The polarizing plate 2 is configured of a polarizer 21, a supporting layer 22 and a retardation film 23. The polarizing plate 2 has a structure in which the polarizer 21 is interposed between the supporting layer 22 and the retardation film 23. The supporting layer 22 and the retardation film 23 are adhered to the polarizer 21 respectively with adhesives 27 and 26.

Similarly, the polarizing plate 3 is configured of a polarizer 31, a supporting layer 32 and a retardation film 33. The polarizing plate 3 has a structure in which the polarizer 31 is interposed between the supporting layer 32 and the retardation film 33. The supporting layer 32 and the retardation film 33 are adhered to the polarizer 31 respectively with adhesives 37 and 36.

In addition, a surface of the polarizing plate 2, which surface is at the side of the retardation film 23, is adhered to a surface of the liquid crystal cell 1 with an adhesive 24, and a coating layer 25 is formed on a surface of the polarizing plate 2, which surface is at the side of the supporting layer 22. With respect to the polarizing plate 3, a surface at the side of the retardation film 33 is adhered to a surface of the liquid crystal cell 1 with an adhesive 34, and a coating layer 35 is formed on a surface at the side of the supporting layer 32. These coating layers 25 and 35 prevent the polarizing plates 2 and 3 from being easily damaged.

The retardation films 23 and 33 have their original function for correcting retardation of light, and an additional function as layers for respectively protecting the polarizers 21 and 31. Each of the retardation films 23 and 33 preferably has a retardation value of 100 nm to 300 nm at a measurement wavelength of 550 nm. In this embodiment, each of the retardation films 23 and 33 has a retardation value of 140 nm at a measurement wavelength of 550 nm. In addition, a uniaxial film, or a biaxial film having a refractive index of approximately 1.4 in the thickness direction, is used for each of the retardation films 23 and 33 for example.

As described, the retardation films 23 and 33 are used with an additional function as the layers for respectively protecting the polarizers 21 and 31, the retardation films 23 and 33 being respectively disposed on the surfaces of the polarizers 21 and 31, which surfaces are at the side of the liquid crystal cell 1. Hence, supporting layers for the respective polarizers 21 and 31 at the side of the liquid crystal cell 1 are unnecessary, and it is possible to thin the polarizing plates 2 and 3.

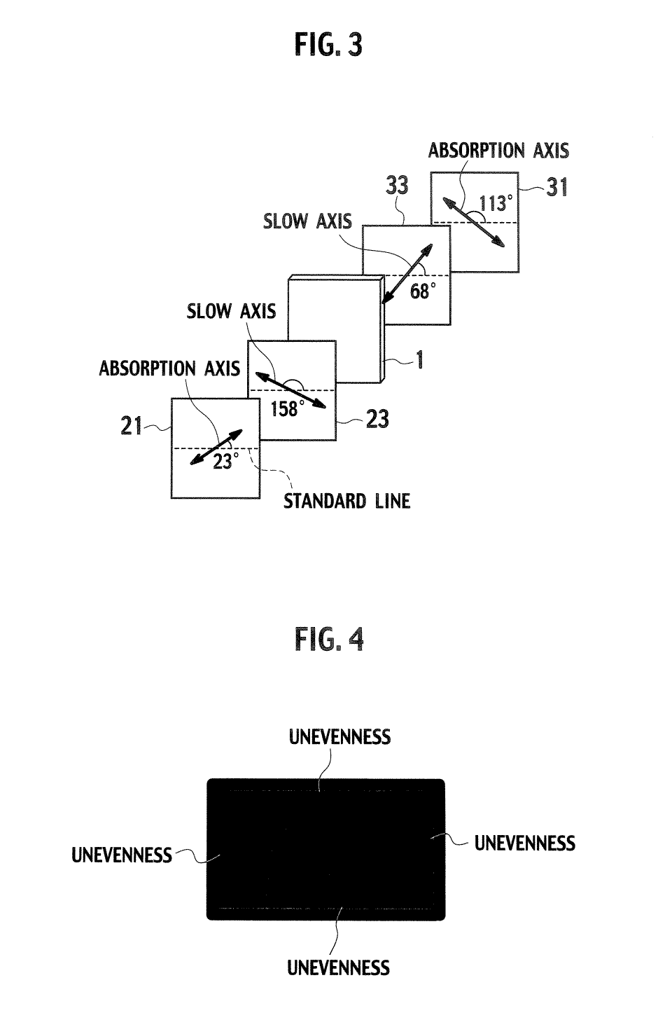

Next, by use of FIG. 3, descriptions will be provided for the axial configuration of the liquid crystal display device. FIG. 3 shows the absorption axes of the respective polarizers 21 and 31, and the slow axes of the respective retardation films 23 and 33 of the disassembled polarizing plates 2 and 3 disposed in a way that the crystal cell 1 is interposed in between. The polarizers 21 and 31, the supporting layers 22 and 32, and the retardation films 23 and 33, which constitute the polarizing plates 2 and 3, are rectangles having approximately identical sizes. Note that the supporting layers 22 and 32 are omitted in FIG. 3.

As shown in FIG. 3, the polarizers 21 and 31 of the respective polarizing plates 2 and 3 are disposed in a way that the absorption axes of the polarizers 21 and 31 orthogonally intersect. The retardation films 23 and 33 are disposed in a way that the slow axes of the corresponding retardation films 23 and 33 are neither parallel nor perpendicular respectively to the absorption axes of the corresponding polarizers 21 and 31. Such disposition makes it possible to reduce the deviation of the slow axes of the retardation films from their original directions and the deviation of retardation values from their original values. Such deviations of slow axes and retardation values result from the polarizers 21 and 31 shrinking in the corresponding absorption directions due to heat in a case where the slow axes are parallel or perpendicular respectively to the absorption axes.

In addition, the polarizers 21 and 31 are disposed in a way that the absorption axes thereof are neither parallel nor perpendicular respectively to any of the sides of the retardation film 23 and any of the sides of the retardation film 33. This disposition enables dispersion of forces applied respectively to the retardation films 23 and 33, the forces being applied thereto because the polarizers 21 and 31 shrink due to heat. Hence, it is possible to further reduce the deviation of the slow axis of the retardation films 23 and 33 from their original directions and the deviation of the retardation values from their original values.

In the liquid crystal display device, the polarizer 21, 31 and the retardation films 23, 33 respectively have standard lines in a common direction. The angle of the absorption axis of the polarizer 21 to its standard line is 23°. The angle of the slow axis of the retardation film 23 to its standard line is 158°. In addition, the angle of the slow axis of the retardation film 33 to its standard line is 68°, and the angle of the absorption axis of the polarizer 31 to its standard line is 113°.

FIG. 4 is an image showing display unevenness occurring in the liquid crystal display device. The display unevenness only slightly appears in the four sides of a display region.

Next, descriptions will be provided for a liquid crystal display device of comparative examples. In each of the comparative examples, retardation films are used with an additional function as layers for respectively protecting polarizers as in the case of the example. However, the polarizers and the retardation films are disposed in a way that the absorption axes of the polarizers are parallel or perpendicular respectively to the slow axes of the retardation films.

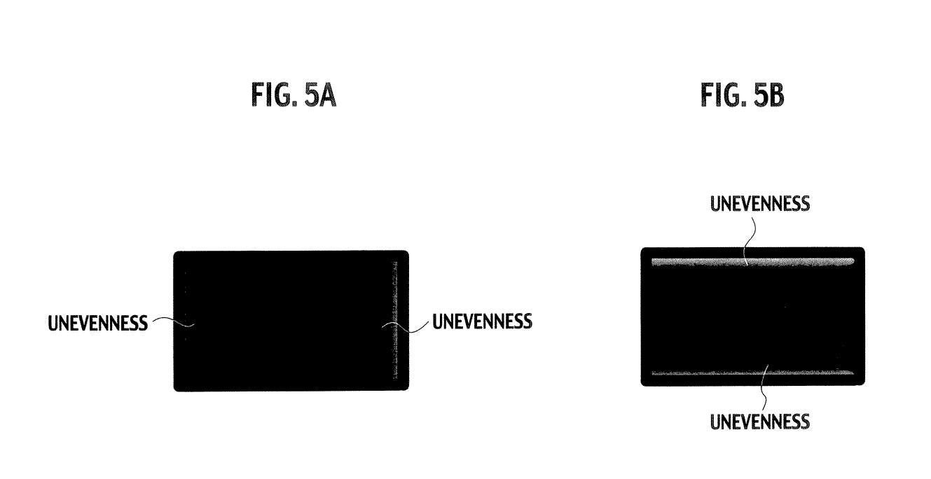

FIG. 5A is an image showing display unevenness of one of the comparative examples. In the comparative example, the polarizers and the retardation films are disposed in a way that the absorption axes of the polarizers extend in the horizontal direction, and that the slow axes of the retardation films are parallel respectively to the absorption axes. Due to the influence of shrinkage of the polarizers in the absorption-axis directions, forces are applied respectively to the retardation films in the horizontal direction, and display unevenness that warps inward occurs in left and right portions of a screen accordingly.

FIG. 5B is an image showing display unevenness of the other comparative example in which the polarizers and the retardation films are disposed in a way that the absorption axes of the polarizers extend in the vertical direction, and that the slow axes of the retardation films are perpendicular respectively to the absorption axes. Due to the influence of the shrinkage of the polarizers in the absorption-axis directions, forces are applied to the retardation films in the vertical direction, and display unevenness that warps inward occurs in top and bottom portions of the screen accordingly.

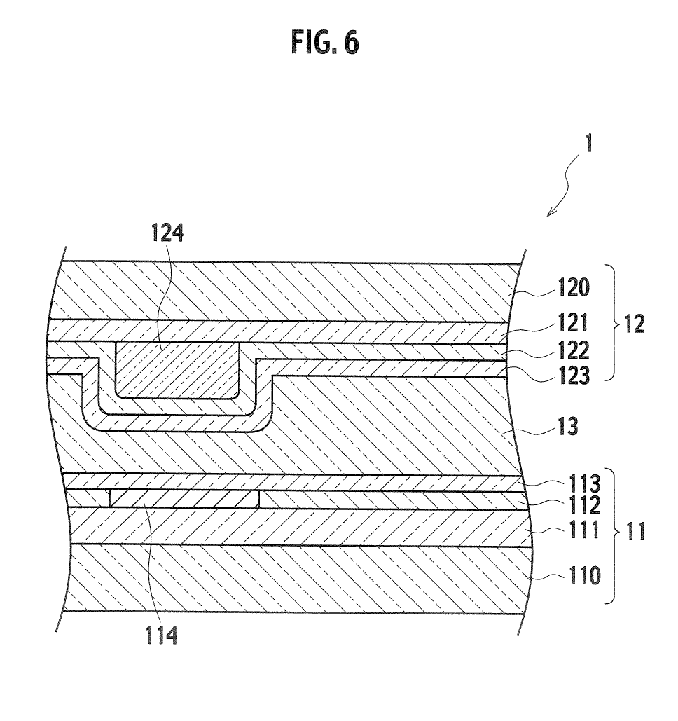

In the example shown in FIG. 4, the display unevenness is dispersed to all the sides of the screen so that the display unevenness does not stand out, as compared to the comparative examples shown in FIGS. 6A and 5B.

FIG. 6 is a cross-sectional view showing a configuration of the liquid crystal cell 1 used for a semi-transparent liquid crystal display device. The liquid crystal cell 1 has a structure in which a liquid crystal layer 13 is interposed between an array substrate 11 and a counter substrate 12 which are disposed opposite to each other. The array substrate 11 is configured of a transparent resin layer 111 formed on a surface of a glass substrate 110 which surface is at the side of the liquid crystal layer 13, transparent electrodes 112, and an alignment film 113. Reflection electrodes 114 are disposed in portions of the respective transparent electrodes 112. The reflection electrodes 114 reflect incident light for the purpose of display. The counter substrate 12 is configured of a color filter 121 formed on a surface of a glass substrate 120 which surface is at the side of the liquid crystal layer 13, transparent electrodes 122, and an alignment film 123. Note that liquid crystals are of a vertically aligned type, and the liquid crystals have a retardation value of 0.092.

The semi-transparent liquid crystal display device has both transparent-display and reflective-display functions. In the transparent display, light from a back light unit is made incident from the side of the array substrate 11. The transmitted light passing through the transparent electrodes 112, the liquid crystal layer 13 and the counter substrate 12 is used for display. In the reflective display, outside light made incident from the side of the counter substrate 12 passes through the liquid crystal layer 13. The light is then reflected on the reflective electrodes 114 of the array substrate 11, and passes through the liquid crystal layer 13 and the counter substrate 12. The reflected light is used for display. Since the reflected light travels back and forth in the liquid crystal layer, the reflected light travels longer in the liquid crystal layer than the transmitted light does. Protruding portions 124 are provided to portions of the counter substrate 12 respectively facing the reflective electrodes 114 in order to thin the liquid crystal layer 13 in the reflective region. The protruding portions reduce the difference between distances of liquid crystal layer of the transparent region and the reflective region. In the embodiment, the liquid crystal layer 13 has a thickness of 3.5 μm in the transparent region, and has a thickness of 2.0 μm in the reflective region.

Note that the polarizing plates 2 and 3 allow only light oscillating in a specific direction to pass through, and the light volume is regulated by use of a voltage applied to the liquid crystal layer 13.

As described above, in the embodiment, the retardation films 23 and 33 are used with an additional function as the layers for respectively protecting the surfaces of the polarizers 21 and 31, each of which surface is at the side of the liquid crystal cell. Thus supporting layers at the side of the liquid crystal layer are unnecessary, and it is possible to thin the polarizing plates 2 and 3.

In addition, the slow axes of the retardation films 23 and 33 are neither parallel nor perpendicular respectively to the absorption axes of the polarizers 21 and 31. Hence, it is possible to reduce the deviation of the slow-axes of the retardation films 23 and 33 from their original directions and the deviation of the retardation values from their original values. The deviations result from the polarizers 21 and 31 shrinking in the case where the slow axes of the retardation films 23 and 33 are parallel or perpendicular respectively to the absorption axes of the polarizers 21 and 31. Because of the reduction of the deviations, it is possible to reduce display unevenness.

In addition, the absorption axes of the polarizers 21 and 31 are neither parallel nor perpendicular respectively to any of the sides of the retardation film 23 and any of the sides of the retardation film 33. Thus forces are dispersed to the sides, the forces being applied respectively to the retardation films 23 and 33 since the polarizers 21 and 31 shrink in the absorption-axis directions. Hence, it is possible to reduce the deviation of the slow-axes of the retardation films 23 and 33 from their original directions and the deviation of the retardation values from their original values, and it is possible to reduce the display unevenness.

What is claimed is:

1. A liquid crystal display device comprising:
a liquid crystal cell including a liquid crystal layer between an array substrate and a counter substrate, which are disposed opposite to each other; and
a pair of polarizing plates respectively provided to both surfaces of the liquid crystal cell,
wherein each of the polarizing plates includes:
a polarizer;
a retardation film which is disposed on a surface of the polarizer, which surface is at the side of the liquid crystal cell, in order to protect the polarizer, and which has a slow axis neither parallel nor perpendicular to an absorption axis of the polarizer; and
a supporting layer disposed on the other surface of the polarizer in order to protect the polarizer.

2. The liquid crystal display device as recited in claim 1, wherein the absorption axis of the polarizer is neither parallel nor perpendicular to any one of the sides of the retardation film.

3. The liquid crystal display device as recited in claim 1, wherein the retardation film has a retardation value of 100 nm to 300 nm at a measurement wavelength of 550 nm.

4. The liquid crystal display device as recited in claim 1, wherein the liquid crystal cell is a semi-transparent one that has transparent electrodes and reflective electrodes in the array substrate.
